(19) United States
(12) Patent Application Publication
(10) Pub. No.: US 2020/0041011 A1
(43) Pub. Date: Feb. 6, 2020

(54) ROTARY VALVE DEVICE AND LIQUID LIFTING DEVICE COMPRISING THE SAME

(71) Applicant: ENERGY HARVEST AS, Sørvågen (NO)

(72) Inventor: Trond Melhus, Sørvågen (NO)

(73) Assignee: ENERGY HARVEST AS, Sørvågen (NO)

(21) Appl. No.: 16/339,068

(22) PCT Filed: Oct. 12, 2016
(86) PCT No.: PCT/EP2016/074497

§ 371 Date: Apr. 3, 2019

(51) Int. Cl. F16K 11/074; F04B 47/00

(52) U.S. Cl. CPC F16K 11/074; F04B 47/00

(57) ABSTRACT

Rotary valve device for sequentially connecting an first line to a plurality of second lines, the rotary valve device comprising: a stationary structure comprising a first port for connection to the first line and at least two second ports for connection to a respective second line and a distribution rotor rotatably arranged within the stationary structure, the distribution rotor comprising at least one rotor opening, wherein the rotary valve device is configured such that the rotor opening sequentially establishes a fluid communication between the first port and the second ports as the distribution rotor rotates.

### TECHNICAL FIELD

The present disclosure generally relates to a rotary valve device. In particular, a rotary valve device for sequentially connecting a first line to a plurality of second lines, a rotary valve assembly comprising two such rotary valve devices, a lifting device comprising the rotary valve device, a lifting device comprising the rotary valve assembly and methods of controlling the lifting devices, are provided.

### BACKGROUND

In a wide range of applications, it is desired to elevate a liquid from a lower reservoir to a higher or upper reservoir which is vertically above the lower reservoir. One example of such application is an elevated reservoir for fish cultivation, where unused sea water is supplied from a lower reservoir to the elevated reservoir and used sea water (e.g. with less oxygen gas) is drained from the elevated reservoir back to the lower reservoir. Further applications include cooling installations for power production, process industry, oil rigs, ships and similar.

US 2002106291 A1 discloses a pumping unit for water supply in remote areas of the world. The pumping unit is used to pump water from a sump to a storage tank above the pumping unit. The pumping unit comprises a pump, a control valve and a tipping bucket mechanism.

PCT/EP2015/073298 filed by Energy Harvest AS discloses a lifting device for vertically lifting liquids. The lifting device comprises a lifting line arrangement for guiding a liquid from a lower reservoir to an upper reservoir, a lowering line arrangement for guiding the liquid from the upper reservoir to the lower reservoir, a pressure converter configured to convert a liquid pressure in the lowering line arrangement into a liquid pressure in the lifting line arrangement.

### SUMMARY

Conventional three-way valves may be difficult to accurately control to deliver a specific flow, such as a charge flow to the pressure converter in PCT/EP2015/073298. For example, some valves lack proportionality between valve position and flow rate. There is also a problem with pressure pulses due to sudden bumping of the valve into its seat, and due to a sudden release of the valve. The reasons for this include static friction, the forces applied, suction effects, etc. Many conventional three-way valves that are used to direct fluid to the chambers of a cylinder comprising a reciprocating piston require a control system where control signals to the valves are calculated based on measures states of the system including the cylinder (e.g. instrumentation to read the piston position).

In a lifting device for vertically lifting liquids from a lower reservoir to an upper reservoir, it is difficult to accurately distribute the charge flow between the two chambers of a pressure converter cylinder comprising a reciprocating piston with conventional three-way valves, in particular during transitions between the strokes. Conventional three-way valves are also often subjected to a relatively high wear.

One object of the present disclosure is to provide an accurate control of one or more displaceable members (e.g. reciprocating pistons) driven by a fluid, in particular of displaceable members of pressure converters in a lifting device for vertically lifting liquids from a lower reservoir to an upper reservoir or a lowering device for vertically lowering liquids from an upper reservoir to a lower reservoir.

A further object of the present disclosure is to provide an accurate control of the fluid volumes delivered by, and/or received from, one or more displaceable members, in particular displaceable members of pressure converters in a lifting device for vertically lifting liquids from a lower reservoir to an upper reservoir.

A still further object of the present disclosure is to provide a valve device that can control one or more fluid driven displaceable members of several cylinders to make a continuous directional change, i.e. a continuous or smooth change between two strokes.

A still further object of the present disclosure is to provide a valve device having a simple and reliable design.

A still further object of the present disclosure is to provide a lifting device for vertically lifting liquids from a lower reservoir to an upper reservoir having a simple and reliable design.

A still further object of the present disclosure is to provide a method that solves at least one of the above objects.

According to one aspect, there is provided a rotary valve device for sequentially connecting a first line to a plurality of second lines, the rotary valve device comprising:
a stationary structure comprising a first port for connection to the first line and at least two second ports for connection to a respective second line; and
a distribution rotor rotatably arranged within the stationary structure, the distribution rotor comprising at least one rotor opening;

wherein the rotary valve device is configured such that the rotor opening sequentially establishes a fluid communication between the first port and the second ports as the distribution rotor rotates.

The rotary valve enables a design where accurate flow rates and/or accurate fluid volumes are delivered to (i.e. a charge) and/or received from (i.e. a return) a fluid driven cylinder comprising a displaceable member. The rotary valve device according to the present disclosure is an alternative to three-way valves. The rotary valve device may be used to control a lifting device, such as the lifting device developed by Energy Harvest AS and described in international application PCT/EP2015/073298. However, other applications for the rotary valve device are possible.

The rotary valve device may be configured to sequentially connect an inlet line to a plurality of outlet lines. In other words, the first line may be constituted by an inlet line and the second lines may be constituted by outlet lines. Alternatively, the rotary valve device may be configured to sequentially connect a plurality of inlet lines to an outlet line. In other words, the first line may be constituted by an outlet line and the second lines may be constituted by inlet lines.

A first chamber may be in immediate fluid communication with the first port. In case the first port is coupled to an inlet line, the first chamber may be arranged downstream of the first port and upstream of the distribution rotor, i.e. the first chamber may be constituted by an inlet chamber. In case the first port is coupled to an outlet line, the first chamber may be arranged upstream of the first port and downstream of the distribution rotor, i.e. the first chamber may be constituted by an outlet chamber. The rotary valve device may comprise more than one first port and a first chamber associated with each first port. For example, the rotary valve device may comprise two first ports and two first chambers.

The rotary valve device may further comprise a second chamber having a plurality of compartments (e.g. four), each associated with a respective second line. The compartments may be defined by one or several compartment walls (also forming part of the stationary structure).

In case the second ports are coupled to outlet lines, the second chamber may be arranged upstream of the second ports and downstream of the distribution rotor, i.e. the second chamber may be constituted by an outlet chamber and the compartments may constitute outlet compartments. In case the second ports are coupled to inlet lines, the second chamber may be arranged downstream of the second ports and upstream of the distribution rotor, i.e. the second chamber may be constituted by an inlet chamber and the compartments may constitute inlet compartments. The first chamber and the second chamber including the compartments may constitute the stationary structure or a part of the stationary structure.

The distribution rotor may be constituted by a disk, i.e. the distribution rotor may have a substantially flat appearance. The rotor opening of the distribution rotor may adopt various different designs. According to one variant, the distribution rotor comprises only one rotor opening. According to a further variant, the distribution rotor comprises more than one rotor opening. Thus, the definition in that the distribution rotor comprises a rotor opening means that the distribution rotor comprises at least one rotor opening. The one or more rotor openings may be designed such that any volume or flow rate profile is delivered therethrough over time, i.e. as the distribution rotor rotates.

According to one example, the rotor opening has an increasing radial extension. A section of the rotor opening with lower radial extension may be arranged “in front” and a section of the rotor opening with higher radial extension may be arranged “behind” in the rotational direction of the distribution rotor. For example, the rotor opening may have a generally droplet shaped appearance where the tip of the droplet “comes first” in the rotation. In case a stator member with stator openings is employed, the section of the rotor opening with lower radial extension may overlap with the stator opening before the section of the rotor opening with higher radial extension overlaps with the stator opening, as the distribution rotor rotates.

Due to its function, the rotary valve device may alternatively be referred to as a rotary distribution valve, rotary diverter valve or rotary sequence valve. The stationary structure may be constituted by, or comprise, a housing.

The distribution rotor may or may not have a uniform cross-sectional design along the rotational axis. One example of a distribution rotor having such uniform cross-sectional design is a distribution rotor having a cylindrical appearance and a rotor opening in the form of a straight hole, i.e. parallel with, and offset from, the rotational axis of the distribution rotor.

The rotary valve device may be configured to establish a fluid communication between the first port and one of the second ports before closing an established fluid communication between the first port and another of the second ports as the distribution rotor rotates. In this manner, if the rotary valve device is used to alternatingly deliver a charge fluid to cylinder chambers to drive a reciprocating piston, a small flow can be guided to the front side (as seen in the movement direction) of the piston before the piston reaches its end position in order to damp the piston at the end positions of the strokes. The same also applies for displaceable members other than pistons, such as diaphragms or membranes.

In any angular position of the distribution rotor, the rotor opening may provide a fluid communication between the first port and one or more of the second ports. Alternatively, or in addition, the rotary valve device may be configured such that fluid communication between the first port and all second ports is prevented at one or more angular positions of the distribution rotor. This may for example be accomplished by increasing the thickness of the compartment walls, by decreasing the length of the rotor opening along the rotational direction (i.e. in the plane of rotation of the distribution rotor), and/or by decreasing the length of the stator openings along the rotational direction.

The distribution rotor may be arranged to rotate continuously. In this manner, the start/stop nature of a conventional valve can be avoided. According to one variant, the distribution rotor is arranged to rotate continuously at a substantially continuous speed (e.g. with less than 5% deviation from an average speed). In this variant, the rotary valve device may be operated completely without any control system other than controlling the motor on and off.

According to one variant, the rotary valve device is configured to control the distribution rotor to rotate with a position dependent speed. For this purpose, a position sensor for sensing the angular position of the distribution rotor and a drive control unit for controlling the rotational speed of the distribution rotor based on the signals from the position sensor, may for example be provided.

The rotor opening may comprise a radially wide portion between two radially narrow portions along a rotational direction of the distribution rotor. A radially wide portion has a longer radial extension than a radially narrow portion. In this manner, a smooth opening and a smooth closing of the of the fluid communication between the first port and the second ports can be realized. This design also enables a smooth operation of a displaceable member such as a piston member.

The rotor opening may comprise a radially outer profile having a shape based on a sine function. In addition, the rotor opening may comprise a radially inner profile having an arc shape. In such a case, the outer profile sine shape may be relative to the arc shape.

The rotary valve device according to the present disclosure may further comprise a stator member fixedly arranged within the stationary structure, downstream of the distribution rotor, wherein the stator member comprises a stator opening associated with each second port. The stator member may, in addition to the distribution rotor, be used to entirely or partly limit the fluid communication between the first port and the second ports. In other words, the stator member may, together with the distribution rotor, determine the timing and properties of flow to the second ports (or to the compartment associated with each second port). The stator member may be constituted by a disk, i.e. the stator member may have a substantially flat appearance.

The rotary valve device may be configured such that a fluid communication between the first port and one or more of the second ports is always established as the distribution rotor rotates. That is, a fluid communication is established between the first port and one or more of the second ports at each angular position of the distribution rotor.

According to a further aspect, there is provided a rotary valve assembly comprising two rotary valve devices according to the present disclosure, wherein the distribution rotors of the rotary valve devices are arranged to rotate synchronously. The rotary valve assembly may be used to control a lifting device. However, other applications for the rotary valve assembly are possible.

Depending on the implementation, a synchronous rotation may or may not require that the distribution rotors are in phase. The two distribution rotors may be offset in phase, i.e. one distribution rotor may be ahead of the other. The phase offset may for example depend on the characteristics of an intermediate volume between the rotary valve devices. The designs and/or dimensions of the rotor openings in the two distribution rotors may be different from each other.

The rotary valve assembly may further comprise a shaft, wherein the distribution rotors of the rotary valve devices are connected via the shaft to rotate synchronously. The shaft may be driven by a motor. The shaft may be fixedly connected to the two distribution rotors (i.e. to rotate in common).

The distribution rotors of the rotary valve devices may alternatively be driven independently, for example by means of two motors. The distribution rotors may be synchronized by means of a standard advanced motor control with accurate position control of the distribution rotors.

The rotary valve assembly may further comprise a hollow shaft motor configured to rotationally drive the shaft. The hollow shaft motor may for example be arranged between the two rotary valve devices.

The rotary valve devices may be connected in fluid series, wherein the second ports of the first rotary valve device are outlet ports and the second ports of the second rotary valve device are inlet ports.

At least two of the second ports of the first rotary valve device may be in fluid communication with a respective second port of the second ports of the second rotary valve device. According to one variant, each second port of the first rotary valve device is in fluid communication with a respective second port of the second rotary valve device. According to one variant, at least one of the second ports of the first rotary valve device is not in fluid communication with a second port of the second rotary valve device. Such second port may for example be guided to a turbine for driving the rotation of one or both of the distribution rotors.

The rotary valve devices may be configured to simultaneously fill a first intermediate volume, between a first of the second ports of the first rotary valve device and a first of the second ports of the second rotary valve device, and drain a second intermediate volume, between a second of the second ports of the first rotary valve device and a second of the second ports of the second rotary valve device, and vice versa.

The two rotary valve devices may be stacked. In case each distribution rotor is driven by a shaft, the shaft may protrude axially out from the stack and there be driven by a motor, for example by a hollow shaft motor. Stacked in this regard means that the rotary valve devices are compactly arranged, for example within a common housing.

According to a further aspect, there is provided a lifting device for vertically lifting liquids, the lifting device comprising a lifting line arrangement for guiding a liquid from a lower reservoir to an upper reservoir; a lowering line arrangement for guiding the liquid from the upper reservoir to the lower reservoir; a pressure converter configured to convert a liquid pressure in the lowering line arrangement into a liquid pressure in the lifting line arrangement, the pressure converter comprising a hollow body and a displaceable member movable within the hollow body in order to substantially sealingly divide the hollow body into two chambers of variable volumes; and a rotary valve device according to the present disclosure; wherein the first port is in fluid communication with the lowering line arrangement, upstream of the pressure converter, and two of the second ports are in fluid communication with a respective chamber of the pressure converter. Throughout the present disclosure, a displaceable member may be constituted by a piston member. However, a displaceable member may alternatively be constituted by a diaphragm or a membrane.

The lifting device may be arranged such that during one rotation of the distribution rotor, the displaceable member makes two strokes, one in each direction, within the hollow body. Hence, the rotary valve device may in this case comprise only two second ports.

The lifting device may allow liquid (e.g. water) to be circulated in a continuous loop formed by the lower reservoir, the lifting line arrangement, the upper reservoir and the lowering line arrangement. The liquid thereby returns to the lower reservoir from which it has been originally pumped. Thus, within the present disclosure, the lower reservoir may be constituted by one single reservoir.

However, it is possible that the lower reservoir is constituted by two reservoirs, e.g. a first lower reservoir and a second lower reservoir. The second lower reservoir may be below the first lower reservoir. In this case, the lifting line arrangement may be configured to guide a liquid from the first lower reservoir to the upper reservoir and the lowering line arrangement may be configured to guide the liquid from the upper reservoir to the second lower reservoir. Both the first lower reservoir and the second lower reservoir may be open to the surrounding atmosphere.

The weight of the liquid head inside the lowering line arrangement above the pressure converter imposes a static force on the displaceable member. Due to this gravital force, the displaceable member is forced to move to impose a corresponding upwardly directed pressure on the liquid in the lifting line arrangement, for example by means of a further displaceable member. Since potential energy of the liquid in the lowering line arrangement is “collected” and used to pump the liquid in the lifting line arrangement upwardly towards the upper reservoir, the lifting device resembles a U-pipe even when being used with an open lower reservoir. The lifting device thereby also functions as an energy recovery apparatus or an energy harvester.

A pressure converter according to the present disclosure may comprise two hollow bodies and a displaceable member (e.g. a reciprocating piston member) arranged within each hollow body. The displaceable members may for example be rigidly coupled by means of a piston rod for a common reciprocation. The hollow body in fluid communication with the rotary valve device may be a lowering hollow body (e.g. through which fluid in the lowering line arrangement is guided) and the other hollow body may be a lifting hollow body (e.g. through which in the lifting line arrangement is pumped).

At each end position, where the displaceable members change directions, the flow delivered by the displaceable member in the lifting hollow body will be zero. When the coupled displaceable members start to accelerate from an end position, the flow rate will increase until a stable flow rate is reached. During the main stroke (e.g. during a major part of the distance moved by the piston member, or by a central portion of a membrane or diaphragm), the flow is stable. When the displaceable members start to decelerate as they approach the opposite end position, the flow rate will decrease until zero. Hence, this type of lifting device will have a variable flow. If the lifting device comprises only one such pressure converter, the speed of the displaceable members will unavoidably vary when accelerating and decelerating to change stroke direction.

Instead of a lifting device according to the present disclosure, a lowering device for vertically lowering liquids may be used. The lowering device may be configured to vertically lower liquids from an upper volume or reservoir where the liquid has a relatively low pressure to a lower volume or reservoir where the liquid has a relatively high pressure. The upper volume and the lower volume may for example be constituted by volumes at different depths.

In such lowering device, each pressure converter may be configured to convert a liquid pressure in a lifting line arrangement into a liquid pressure in a lowering line arrangement. Thus, instead of using the gravital force of a liquid head inside the lowering line arrangement, as in the lifting device, the lowering device can use of the higher pressure in the lifting line arrangement. In other words, the lifting device lifts liquids against the gravital force while the lowering device lowers liquids against a counter force, e.g. a height difference between two liquid volumes.

A lifting device and a lowering device according to the present disclosure may be collectively referred to as a device for vertically pumping liquids. Unless otherwise indicated, a lowering device may have a reverse configuration and operation with respect to a lifting device.

According to a further aspect, there is provided a lifting device for vertically lifting liquids, the lifting device comprising a lifting line arrangement for guiding a liquid from a lower reservoir to an upper reservoir; a lowering line arrangement for guiding the liquid from the upper reservoir to the lower reservoir; a plurality of pressure converters, each configured to convert a liquid pressure in the lowering line arrangement into a liquid pressure in the lifting line arrangement, wherein each pressure converter comprises a hollow body and a displaceable member movable within the hollow body in order to substantially sealingly divide the hollow body into two chambers of variable volumes; and a rotary valve device according to the present disclosure; wherein the first port is in fluid communication with the lowering line arrangement, upstream of the pressure converters, and two of the second ports are in fluid communication with a respective chamber of each pressure converter. The plurality of pressure converters may be fluidically parallel.

The definition in that two of the second ports are in fluid communication with a respective chamber of each pressure converter means that a first second port of a first pair of second ports is in fluid communication with a first chamber of a first pressure converter, a second port of the first pair of second ports is in fluid communication with a second chamber of the first pressure converter, a first second port of a second pair of second ports is in fluid communication with a first chamber of a second pressure converter, and a second port of the second pair of second ports is in fluid communication with a second chamber of the second pressure converter etc.

In case a plurality of pressure converters are provided, the flow rate of the liquid in the lifting line arrangement, pumped by the plurality of pressure converters to the upper reservoir, can be made stable, i.e. fluctuations in flow and pressure can be eliminated. In this lifting device, the rotary valve device may be driven without control system.

According to one variant, the lifting device comprises two pressure converters. According to a further variant, the lifting device comprises more than two pressure converters, such as for example four, eight, twelve or twenty four pressure converters. If the lifting device comprises more than two pressure converters, one or more pressure converters may be taken out of service while maintaining a stable flow. One or more of the pressure converters may serve as backup, either temporarily or permanent.

A lifting device comprising a plurality of pressure converters might still generate some pressure pulsations and flow variations. However, the more pressure converters that are provided, the lesser the pulsations and flow variations become. Additionally, one or more pressure dampeners may be installed in the lifting device. These may be of any known type.

Throughout the present disclosure, a lifting device comprising only one pressure converter may be referred to as a single energy harvest configuration and a lifting device comprising a two pressure converters may be referred to as a dual energy harvest configuration.

According to a further aspect, there is provided a lifting device for vertically lifting liquids, the lifting device comprising a lifting line arrangement for guiding a liquid from a lower reservoir to an upper reservoir; a lowering line arrangement for guiding the liquid from the upper reservoir to the lower reservoir; a pressure converter configured to convert a liquid pressure in the lowering line arrangement into a liquid pressure in the lifting line arrangement, the pressure converter comprising a hollow body and a displaceable member movable within the hollow body in order to substantially sealingly divide the hollow body into two chambers of variable volumes; and a rotary valve assembly according to the present disclosure; wherein the first port of the first rotary valve device is in fluid communication with the lowering line arrangement, upstream of the pressure converter, two of the second ports of the first rotary valve device are in fluid communication with a respective chamber of the pressure converter, two of the second ports of the second rotary valve device are in fluid communication with a respective chamber of the pressure converter, and the first port of the second rotary valve device is in fluid communication with the lowering line arrangement, downstream of the pressure converter.

According to a further aspect, there is provided a lifting device for vertically lifting liquids, the lifting device comprising a lifting line arrangement for guiding a liquid from a lower reservoir to an upper reservoir; a lowering line arrangement for guiding the liquid from the upper reservoir to the lower reservoir; a plurality of pressure converters, each configured to convert a liquid pressure in the lowering line arrangement into a liquid pressure in the lifting line arrangement, each pressure converter comprising a hollow body and a displaceable member movable within the hollow body in order to substantially sealingly divide the hollow body into two chambers of variable volumes; and a rotary valve assembly according to the present disclosure; wherein the first port of the first rotary valve device is in fluid communication with the lowering line arrangement, upstream of the pressure converters, two of the second ports of the first rotary valve device are in fluid communication with a respective chamber of each pressure converter, two of the second ports of the second rotary valve device are in fluid communication with a respective chamber of each pressure converter, and the first port of the second rotary valve device is in fluid communication with the lowering line arrangement, downstream of the pressure converters.

According to a further aspect, there is provided a method of controlling a lifting device according to the present disclosure, the method comprising in a first sequence, sequentially establishing a fluid communication between the first port and each of the second ports associated with the first chamber of each pressure converter by rotating the distribution rotor; and in a second sequence, following the first sequence, sequentially establishing a fluid communication between the first port and each of the second ports associated with the second chamber of each pressure converter by rotating the distribution rotor.

According to a further aspect, there is provided a method of controlling a lifting device according to the present disclosure, the method comprising in a first opening sequence, sequentially establishing a fluid communication between the first port of the first rotary valve device and each of the second ports of the first rotary valve device associated with the first chamber of each pressure converter by rotating the distribution rotor; and in a second opening sequence, following the first opening sequence, sequentially establishing a fluid communication between the first port of the first rotary valve device and each of the second ports of the first rotary valve device associated with the second chamber of each pressure converter by rotating the distribution rotor.

The method may further comprise in a first closing sequence, sequentially closing a fluid communication between the second port of the second rotary valve device associated with the first chamber of each pressure converter by rotating the distribution rotor; and in a second closing sequence, following the first closing sequence, sequentially closing a fluid communication between the second port of the second rotary valve device associated with the second chamber of each pressure converter by rotating the distribution rotor.

The first opening sequence and the first closing sequence may be carried out simultaneously, and the second opening sequence and the second closing sequence may be carried out simultaneously, such that a fluid communication between the first port of the first rotary valve device and the second port of the first rotary valve device associated with the first chamber of one pressure converter is established substantially at the same time as the fluid communication between the second port of the second rotary valve device associated with the first chamber of the pressure converter and the first port of the second rotary valve device is closed.

### BRIEF DESCRIPTION OF THE DRAWINGS

Further details, advantages and aspects of the present disclosure will become apparent from the following embodiments taken in conjunction with the drawings, wherein:

FIG. 1: schematically represents front views of some components of a rotary valve device;

FIG. 2: schematically represents a cross-sectional side view of the rotary valve device;

FIG. 3: shows an example of flow pattern of the rotary valve device in FIG. 2;

FIG. 4: schematically represents a shape of a rotor opening and a stator opening;

FIG. 5 schematically represents different angular positions of the rotor opening relative to the stator opening;

FIG. 6: schematically represents a rotary valve assembly comprising two rotary valve devices;

FIG. 7: schematically represents an exploded perspective view of some components of a further rotary valve assembly comprising two rotary valve devices;

FIG. 8: schematically represents a perspective view of some components of the rotary valve assembly in FIG. 7 in an assembled state;

FIG. 9: schematically represents a perspective and partially cut out view of some components of the rotary valve assembly in FIGS. 5 and 6;

FIG. 10: schematically represents a lifting device comprising two rotary valve devices and one pressure converter;

FIG. 11: shows an example of flow pattern of the rotary valve devices in FIG. 10;

FIG. 12: schematically represents a lifting device comprising two rotary valve devices and two pressure converters; and

FIG. 13: shows an example of flow pattern of the rotary valve devices in FIG. 12.

### DETAILED DESCRIPTION

In the following, a rotary valve device for sequentially connecting a first line to a plurality of second lines, a rotary valve assembly comprising two such rotary valve devices, a lifting device comprising the rotary valve device, a lifting device comprising the rotary valve assembly and methods of controlling the lifting devices, will be described. The same reference numerals will be used to denote the same or similar structural features.

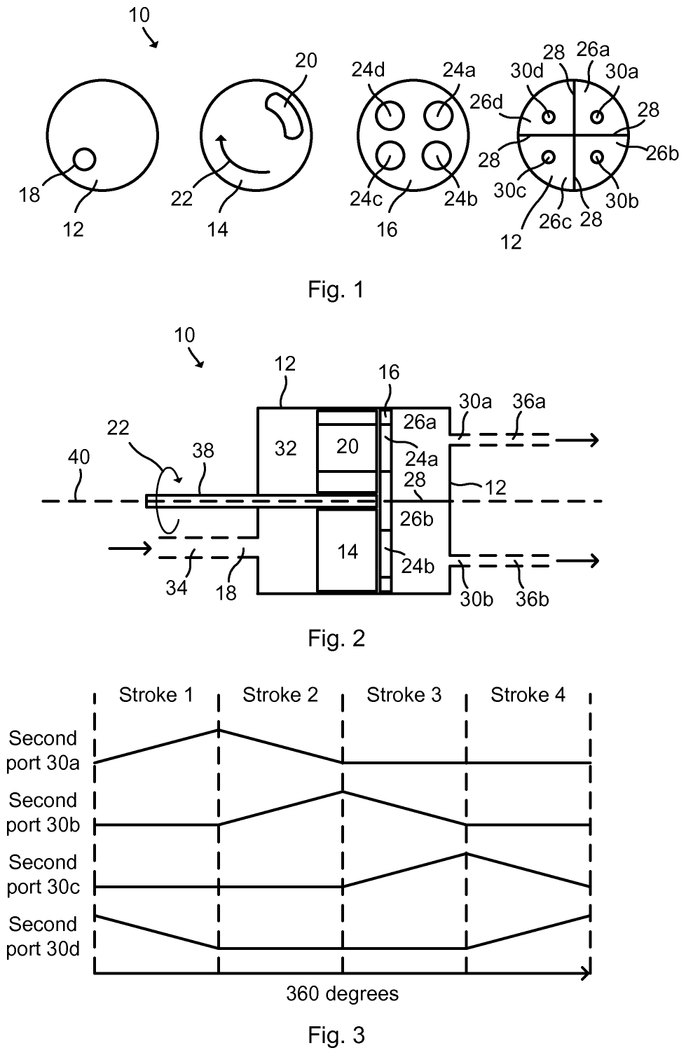

FIG. 1 schematically represents front views of some components of a rotary valve device 10. The rotary valve device 10 of this example comprises a stationary structure 12, a distribution rotor 14 and a stator member 16. A first part (the leftmost in FIG. 1) of the stationary structure 12 forms a first chamber and comprises a first port 18 for connection to a first line or conduit for fluid communication into or out from the first chamber.

The distribution rotor 14 is here implemented as a substantially flat and circular disk. A rotor opening 20 is provided in the distribution rotor 14 and extends fully therethrough. In this implementation, the rotor opening 20 has an elongated curved profile that extends approximately 70° along the rotational direction 22.

The stator member 16 comprises a plurality of stator openings, generally designated 24. In FIG. 1, the stator member 16 comprises four stator openings 24a, 24b, 24c, 24d. In this implementation, the stator member 16 is a substantially flat disk and the stator openings 24 are circular through holes. The stator member 16 may be fixedly attached to the stationary structure 12 or may be integrally formed with the stationary structure 12.

A second part (the rightmost in FIG. 1) of the stationary structure 12 forms a second chamber which is divided into four compartments 26a, 26b, 26c, 26d by means of compartment walls 28. The stationary structure 12 comprises a plurality of second ports, generally designated 30. In this example, the stationary structure 12 comprises four second ports 30a, 30b, 30c, 30d. Each stator opening 24a, 24b, 24c, 24d of the stator member 16 is associated with a respective compartment 26a, 26b, 26c, 26d and a respective second port 30a, 30b, 30c, 30d.

The rotary valve device 10 may comprise additional components than shown in FIG. 1. It should also be noted that the stator member 16 may be omitted.

FIG. 2 schematically represents a cross-sectional side view of the rotary valve device 10. In FIG. 2, it can be seen how the first part (the leftmost in FIG. 2) of the stationary structure 12 forms the first chamber 32 and how the second part (the rightmost in FIG. 2) of the stationary structure 12 forms the second chamber comprising the compartments 26a, 26b, 26c, 26d (only two are visible in FIG. 2) defined by the compartment walls 28.

The distribution rotor 14 is rotatably arranged within the stationary structure 12. In this example, the stationary structure 12 is implemented as a housing.

FIG. 2 further shows that the first port 18 can be coupled to a first line 34 and that each second port 30a, 30b, 30c, 30d (only two are visible in FIG. 2) can be coupled to a respective second line 36a, 36b, 36c, 36d (only two are visible in FIG. 2). The second lines 36a, 36b, 36c, 36d are generally designated 36. As illustrated with the arrows, the first line 34 is an inlet line and the second lines 36a, 36b, 36c, 36d are outlet lines in this implementation. However, the reverse configuration is possible which will be described in the following.

The rotary valve device 10 further comprises shaft 38. The shaft 38 is fixedly coupled to the distribution rotor 14 and the two parts rotate together about a rotational axis 40. As the distribution rotor 14 rotates, the rotor opening 20 becomes aligned with one of the stator openings 24a, 24b, 24c, 24d and thereby sequentially connects the first chamber 32 to one of the compartments 26a, 26b, 26c, 26d. As a consequence, the rotary valve device 10 sequentially establishes a fluid communication between the first port 18 and one of the second ports 30a, 30b, 30c, 30d.

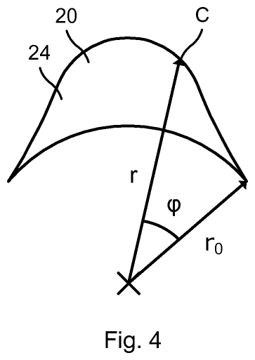

FIG. 3 shows an example of flow pattern of the rotary valve device 10 in FIG. 2. Four strokes are generated as the distribution rotor 14 rotates 360°. The flow rate is determined by the geometry of the rotor opening 20 of the distribution rotor 14. The example is not according to the geometry in FIG. 1.

In the first stroke, the rotor opening 20 is aligned with the compartment 26a such that the fluid is allowed to flow from the first port 18 to the second port 30a. In the second stroke, the rotor opening 20 is aligned with the compartment 26b such that the fluid is allowed to flow from the first port 18 to the second port 30b, the opening between the first port 18 and the second port 30a is closed and the fluid remaining inside the compartment 26a may be drained. As an alternative to draining, the fluid may be kept within the compartment 26a for some time and a pressure buildup may be established.

In the third stroke, the rotor opening 20 is aligned with the compartment 26c such that the fluid is allowed to flow from the first port 18 to the second port 30c, the opening between the first port 18 and the second port 30b is closed and the fluid remaining inside the compartment 26b is drained. In the fourth stroke, the rotor opening 20 is aligned with the compartment 26d such that the fluid is allowed to flow from the first port 18 to the second port 30d, the opening between the first port 18 and the second port 30c is closed and the fluid remaining inside the compartment 26c is drained. When the first stroke is carried out anew, the rotor opening 20 is aligned with the compartment 26a such that the fluid is allowed to flow from the first port 18 to the second port 30a, the opening between the first port 18 and the second port 30d is closed and the fluid remaining inside the compartment 26d is drained.

Draining of the compartments 26a, 26b, 26c, 26d may be accomplished by means of gravity. For this purpose, the rotary valve device 10 may be oriented such that the rotational axis 40 comprises a directional component in the vertical direction. The rotational axis 40 may for example be substantially vertically oriented. Alternatively, the second ports 30a, 30b, 30c, 30d may be arranged in a lower region of the respective compartment 26a, 26b, 26c, 26d to effect the draining.

In the above flow pattern example, the rotor opening 20 is relatively short and thereby directs a fluid flow from the first port 18 to one of the second ports 30a, 30b, 30c, 30d. However, the rotor opening 20 may be extended (and/or the compartment walls 28 may be made thinner and/or the stator openings 24a, 24b, 24c, 24d may be made bigger) to cover several compartments 26a, 26b, 26c, 26d, i.e. such that the rotor opening 20 directs a fluid flow from the first port 18 to two adjacent second ports 30a, 30b, 30c, 30d during transitions between one, some or all of the strokes. Also in this variant, the rotor opening 20 sequentially establishes a fluid communication between the first port 18 and the second ports 30a, 30b, 30c, 30d. The distribution rotor 14 and the stator member 16 may be designed in various forms to create advanced flow rate patterns between the first port 18 and the second ports 30a, 30b, 30c, 30d as the distribution rotor 14 rotates within the stationary structure 12.

FIG. 4 schematically represents a shape of a rotor opening 20 for a distribution rotor 14 (not shown in FIG. 4) according to the present disclosure. With reference to FIG. 4, the shape of the rotor opening 20 will be described. The illustrated shape of the rotor opening 20 may also be used for the stator opening 24. In this case, also the size of the rotor opening 20 and the size of the stator opening 24 may be the same.

The rotor opening 20 comprises a centre portion that is relatively long in the radial direction and two outer portions that are relatively short in the radial direction. The rotor opening 20 thus comprises a radially wide portion between two radially narrow portions along a rotational direction of the distribution rotor 14.

The rotor opening 20 comprises a radially outer profile having a shape based on a sine function and a radially inner profile having an arc shape. In this way, it is possible to generate a flow area with a sine shape as the distribution rotor 14 rotates.

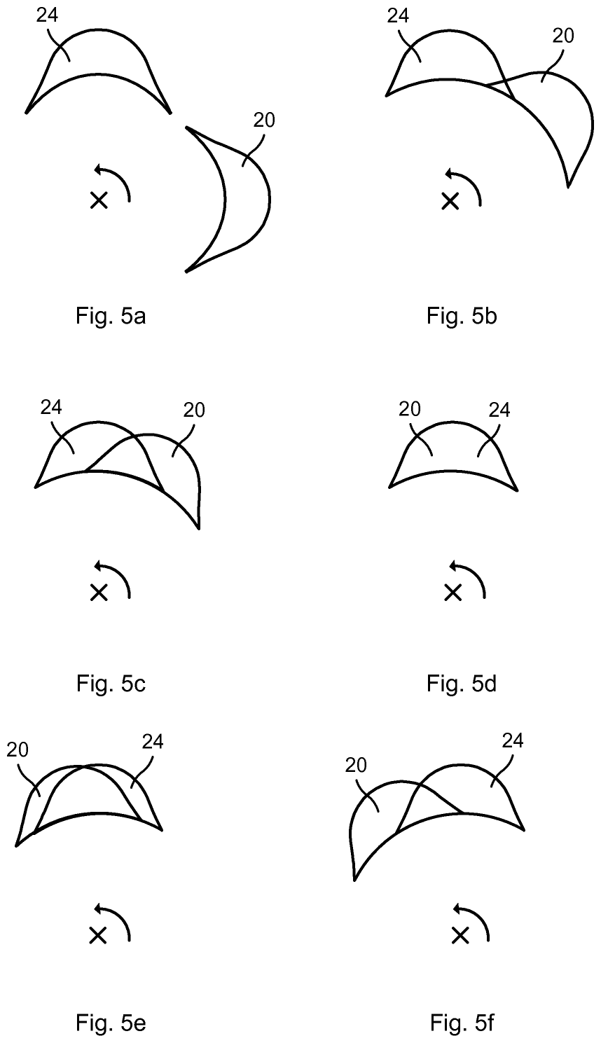

FIGS. 5a to 5f schematically represents different angular positions of the rotor opening 20 relative to the stator opening 24 during rotation of the distribution rotor 14. In FIG. 5a, there is no overlap between the rotor opening 20 and the stator opening 24. Consequently, no fluid communication is established between the first port 18 and the second port 30 associated with the stator opening 24.

In FIG. 5b, the rotor opening 20 has rotated into a position where a radially narrow outer portion of the rotor opening 20 overlaps with a radially narrow outer portion of the stator opening 24. As a consequence, a fluid communication between the first port 18 and the second port 30 associated with the stator opening 24 is established.

In FIG. 5c, the area of the overlap has increased until a full overlap is reached, as illustrated in FIG. 5d, where the rotor opening 20 and the stator opening 24 are aligned. In FIGS. 5e and 5f, the area of the overlap decreases due to the continuing rotation of the rotor opening 20 until the fluid communication between the first port 18 and the second port 14 associated with the stator opening 24 is closed.

With this design of the rotor opening 20 and the stator opening 24, a smooth opening and a smooth closing of the of the fluid communication between the first port 18 and the second ports 30 can be realized. A smooth flow is also generated during the period when the fluid communication is established between the first port 18 and the second port 30 associated with the stator opening 24. A relatively large overlapping area between the rotor opening 14 and the stator opening 24 can also be maintained over a longer time. This design enables a smooth operation of a displaceable member (shown in the following) and a more accurate control of flows.

The distribution rotor 14 may comprise one or several, such as two or three, rotor openings 20 shown in FIG. 4 and the stator member 16 may comprise a corresponding amount of stator openings 24.

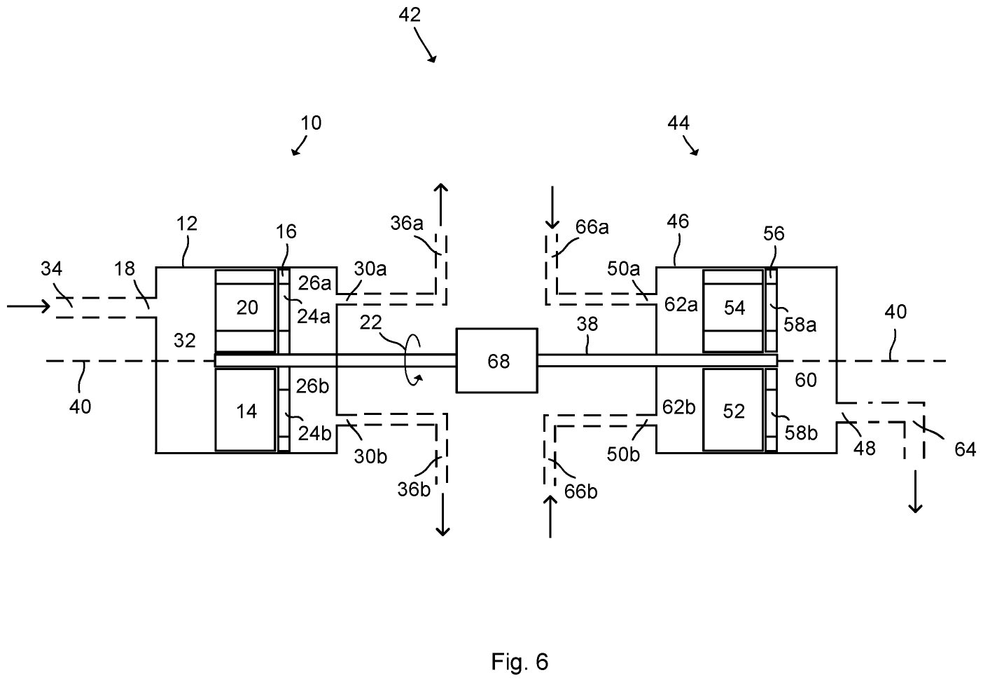

FIG. 6 schematically represents a rotary valve assembly 42 comprising two rotary valve devices 10, 44. The rotary valve device 10 is of the same type as in FIG. 2, i.e. the first port 18 is adapted for connection to a first line 34 in the form of an inlet line and the second ports 30a, 30b, 30c, 30d are adapted for connection to second lines 36a, 36b, 36c, 36d in the form of outlet lines. The rotary valve assembly 42 may be used to control a lifting device comprising a plurality of pressure converters, as will be described below.

Similarly to the rotary valve device 10, the rotary valve device 44 also comprises a stationary structure 46, a first port 48, second ports 50a, 50b, 50c, 50d, (generally designated 50), a distribution rotor 52 having a rotor opening 54, a stator member 56 having stator openings 58a, 58b, 58c, 58d (generally designated 58), a first chamber 60, and a second chamber having compartments 62a, 62b, 62c, 62d (generally designated 62).

In the rotary valve assembly 42 of FIG. 6, the rotary valve device 44 is reversely configured with respect to the rotary valve device 10, i.e. the first port 18 is adapted for connection to a first line 64 in the form of an outlet line and the second ports 50a, 50b, 50c, 50d (only two are shown) are adapted for connection to second lines 66a, 66b, 66c, 66d (only two are shown) in the form of inlet lines. The second lines 66a, 66b, 66c, 66d are generally designated 66. The area of each second line 66 should not exceed the area of an associated second line 36. Preferably, the area of each second line 66 is the same as the area of an associated second line 36.

In each rotary valve device 10, 44, the stator member 16, 56 is arranged downstream of the distribution rotor 14, 52. However, in the rotary valve device 10, the distribution rotor 14 is arranged between the first port 18 and the stator member 16 and in the rotary valve device 44, the stator member 56 is arranged between the distribution rotor 52 and the first port 48.

As shown in FIG. 6, the two distribution rotors 14, 52 are fixedly connected to the shaft 38 and the three parts rotate together about the rotational axis 40. The rotary valve assembly 42 further comprises a hollow shaft motor 68 for rotationally driving the shaft 38. The hollow shaft motor 68 is arranged between the two rotary valve devices 10, 44.

The rotational speed of the shaft 38 may be constant. However, there might be situations where different speed settings at different angular positions around the rotational axis 40 is beneficiary. This could be used as a measure to fine tune hydro-dynamic behaviour on a pressure converter.

For example, if pressure pulsations occur in an installed pressure converter, or if there are problems with the strokes due to overfilled or underfilled chambers in the pressure converters, the rotational speed of the shaft 38 can be adjusted (in theory to zero speed) to allow for shorter or longer fluid communication periods for a connection between a first port 18, 48 and a certain second port 30a, 30b, 30c, 30d, 50a, 50b, 50c, 50d. This control may be applied to only one of the rotary valve devices 10, 44 or to both of the rotary valve devices 10, 44. According to one variant, the control comprises one particular rotational speed target value for each angular position around the full rotation.

This control may be implemented by known motor drive control systems such as SCR (Silicon Controlled Rectifier) or VFD (Variable Frequency Drive). As one example, a speed setting, e.g. for each degree around the full rotation can be programmed and these settings can be derived from mathematical calculations.

As a further example, an offset curve for speed settings around the full rotation can be applied. This offset curve can be, or be derived from, a log from operation of the system (e.g. a lifting device according to the present disclosure). One way to establish such offset curve is to permanently or temporarily install a flow meter in the fluid loop, and record the flow values together with the position of the motor 68 and/or the shaft 38. By subtracting the ideal flow rate around the rotation, the resulting curve will be the offset curve. The same can be done with e.g. pressure measurements instead of flow measurements, but this will require more calculation steps to establish the offset curve.

As a further example, offset information can be fed directly to a rotational control device. This is a real-time version of the previous method, where measurements are used directly as a speed offset setting (raw or after calculations).

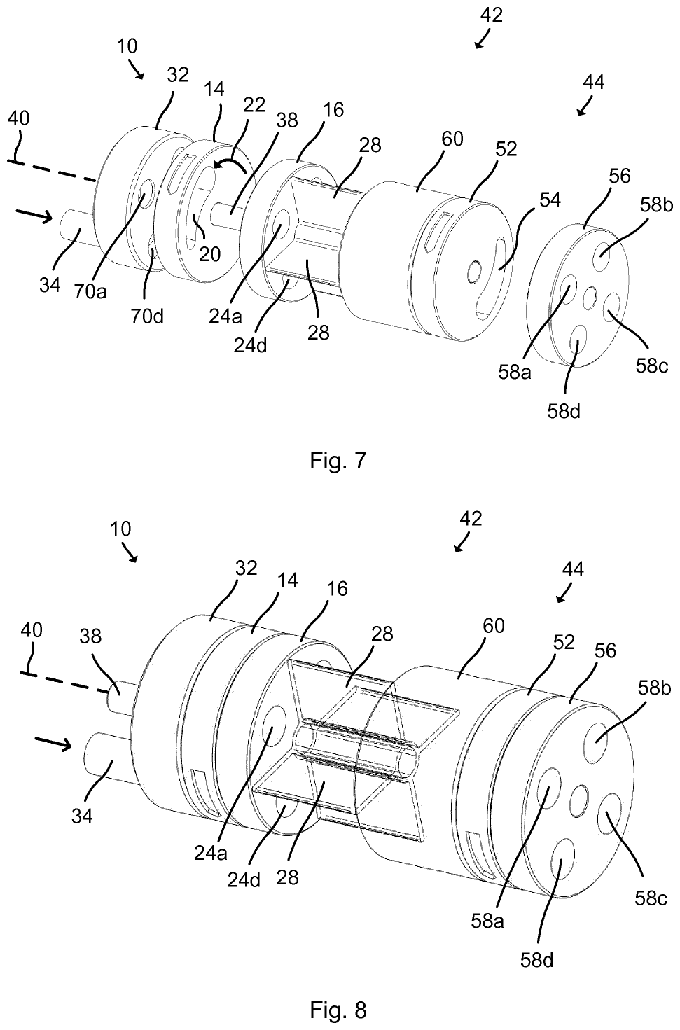

FIG. 7 schematically represents an exploded perspective view of some components of a further rotary valve assembly 42 comprising two rotary valve devices 10, 44. In FIG. 7, it can be gathered that the first chamber 32 of the rotary valve device 10 comprises four first chamber openings 70a, 70b, 70c, 70d (only two are shown). Each first chamber opening 70a, 70b, 70c, 70d is substantially aligned with a respective stator opening 24a, 24b, 24c, 24d (only two are shown) of the stator member 16. The first chamber 60 of the rotary valve device 44 also comprises four first chamber openings (not shown) associated with the stator openings 58a, 58b, 58c, 58d of the stator member 56.

FIG. 7 further shows that the rotor openings 20, 54 of the rotary valve devices 10, 44 have a generally droplet shaped appearance where the tip of the droplet “comes first” in the rotation direction 22. Moreover, it can be seen that each of the distribution rotors 14, 52 and the stator members 16, 56 are disks having a substantially flat appearance. In this example, each disk has a diameter that is approximately four times its thickness (along the rotational axis 40). However, the thicknesses may be varied depending on the implementation. The compartment walls 28 are substantially perpendicular to each other.

FIG. 8 schematically represents a perspective view of some components of the rotary valve assembly 42 in FIG. 7 in an assembled state. In FIG. 8, the rotary valve devices 10, 44 are stacked in a compact configuration. The shaft 38 protrudes from one side of the stack, i.e. from the side where the rotary valve device 10 is arranged. The distribution rotors 14, 52 are fixedly connected to the shaft 38 for a common rotation around the rotational axis 40. The shaft 38 may be driven by a motor (not shown), such as the hollow shaft motor 68. The two rotary valve devices 10, 44 may be arranged within a common housing.

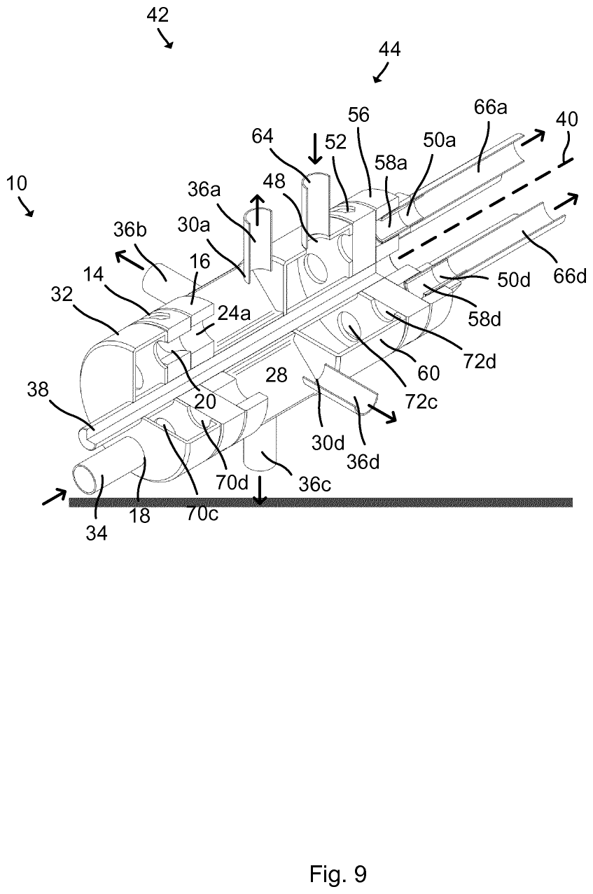

FIG. 9 schematically represents a perspective and partially cut out view of some components of the rotary valve assembly 42 in FIGS. 7 and 8. Each of these rotary valve devices 10, 44 is similar to FIG. 2 in that the first port 18 of the rotary valve device 10 is connected to a first line 34 in the form of an inlet line, the second ports 30a, 30b, 30c, 30d (only two are shown) of the first rotary valve device 10 are connected to a respective second line 36a, 36b, 36c, 36d in the form of outlet lines, the first port 48 of the rotary valve device 44 is connected to a first line 64 in the form of an inlet line and the second ports 50a, 50b, 50c, 50d (only two are shown) of the rotary valve device 44 is connected to a plurality of second lines 66a, 66b, 66c, 66d (only two are shown) in the form of outlet lines.

The rotary valve device 10 in FIG. 9 is also similar to FIG. 2 in that it comprises a second chamber having a plurality of compartments divided by compartment walls 28. However, the rotary valve device 44 in FIG. 9 differs from the rotary valve device 10 in FIG. 2 in that it does not comprise such second chamber. Instead, the second ports 50a, 50b, 50c, 50d are directly attached to a respective associated stator opening 58a, 58b, 58c, 58d of the stator member 56. FIG. 9 further shows four first chamber openings 72a, 72b, 72c, 72d (only two are denoted) of the first chamber 60 of the rotary valve device 44.

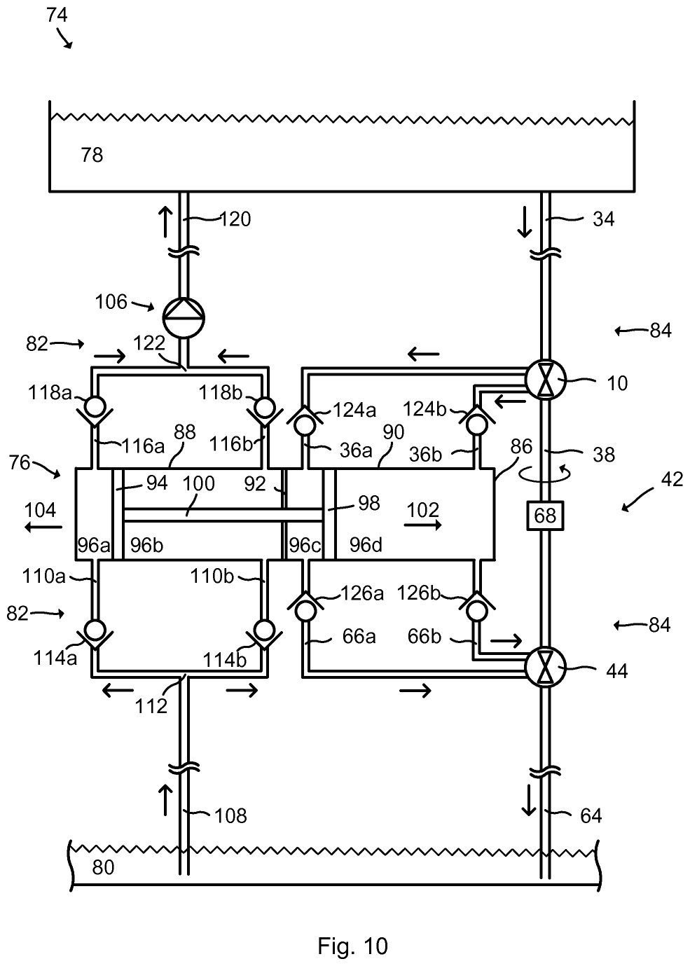

FIG. 10 schematically represents a lifting device 74 comprising a pressure converter 76 and a rotary valve assembly 42 substantially in accordance with FIG. 6 having two rotary valve devices 10, 44. The rotary valve devices 10, 44 however differ by comprising only two second ports 30a, 30b, 50a, 50b (not shown). In FIG. 10, the lifting device 74 is in operation with an upper reservoir 78 and a lower reservoir 80. FIG. 10 thus also shows a system comprising the lifting device 74, the upper reservoir 78 and the lower reservoir 80.

The upper reservoir 78 is positioned at a higher elevation than the lower reservoir 80, for example 20 meters above the lower reservoir 80. In this implementation, both the upper reservoir 78 and the lower reservoir 80 are open to the surrounding atmosphere. In FIG. 10, the upper reservoir 78 is a tank and the lower reservoir 80 is a lake. However, the upper reservoir 80 can be a closed vessel like a tank, and the upper reservoir 80 can also be pressurized.

The lifting device 74 comprises a lifting line arrangement and a lowering line arrangement, generally designated by reference numerals 82 and 84, respectively. As can be seen in FIG. 1, the lifting line arrangement 82 is configured to guide a liquid from the lower reservoir 80 to the pressure converter 76 and to guide the liquid from the pressure converter 76 to the upper reservoir 78. The lowering line arrangement 84 is configured to guide a liquid from the upper reservoir 78 to the pressure converter 76 and to guide the liquid from the pressure converter 76 back to the lower reservoir 80.

The pressure converter 76 in FIG. 1 comprises a tubular member 86 in the form of a cylinder. The tubular member 86 is divided into two hollow bodies 88, 90 by means of a partition wall 92. The two hollow bodies 88, 90 are integrally formed in FIG. 1. The hollow body 88 in connection with the lifting line arrangement 82 is referred to as a lifting hollow body 88 and the hollow body 90 in connection with the lowering line arrangement 84 is referred to as a lowering hollow body 90.

A displaceable member 94, here implemented as a piston member, is slidably arranged inside the lifting hollow body 88 and thereby divides the lifting hollow body 88 into a left lifting chamber 96a and a right lifting chamber 96b of variable volumes. Similarly, a displaceable member 98, here implemented as a piston member, is slidably arranged inside the lowering hollow body 90 and thereby divides the lowering hollow body 90 into a left lowering chamber 96c and a right lowering chamber 96d. The left lowering chambers 96c and the right lowering chambers 96d constitute one example of an intermediate volume according to the present disclosure.

The displaceable members 94, 98 may be provided with sealing rings as necessary in order to maintain a fluid tight seal, or at least a substantially fluid tight seal, between the lifting chambers 96a, 96b and between the lowering chambers 96c, 96d. In FIG. 1, the displaceable members 94, 98 are constituted by conventional pistons, i.e. rigid pistons slidably arranged with respect to the interior surfaces of the respective hollow bodies 88, 90.

A piston rod 100 interconnects the displaceable members 94, 98. The displaceable members 94, 98 are attached to the respective ends of the piston rod 100. The piston rod 100 and the displaceable members 94, 98 are arranged to reciprocate as a unit with respect to the hollow bodies 88, 90 back and fourth as indicated by arrows 102 and 104. The tubular member 86 constitutes a housing for the displaceable members 94, 98 and the piston rod 100.

The piston rod 100 is arranged to move substantially linearly through an opening in the partition wall 92. A sealing is provided in this opening in order to avoid fluid communication between the hollow bodies 88, 90.

The lifting device 74 further comprises a pump member 106. The pump member 106 is arranged to assist in pumping liquid in the lifting line arrangement 82 upwards towards the upper reservoir 78. The pump member 106 is constituted by a conventional pump, preferably a volumetric pump such as a lobe pump, and may be driven electrically.

In FIG. 1, the pump member 106 is positioned in the lifting line arrangement 82 between the pressure converter 76 and the upper reservoir 78. However, alternative positions of the pump member 106 are possible.

The particular layouts of the lifting line arrangement 82 and the lowering line arrangement 84 will now be described in more detail. The lifting line arrangement 82 comprises a lower supply conduit 108 with a lower end submerged in the lower reservoir 80. The lower supply conduit 108 branches into two inlets in the form of two inlet conduits 110a, 110b at a junction 112. The left inlet conduit 110a is connected to (associated with) the left lifting chamber 96a and the right inlet conduit 110b is connected to the right lifting chamber 96b.

A one-way valve 114a is provided on the left inlet conduit 110a and a one-way valve 114b is provided on the right inlet conduit 110b. The one-way valves 114a, 114b allow liquid to pass from the lower reservoir 80 to the lifting hollow body 88 of the pressure converter 76, but prevents liquid from passing in the opposite direction.

The lifting line arrangement 82 further comprises a left outlet in the form of a left outlet conduit 116a connected to the left lifting chamber 96a and a right outlet in the form of a right outlet conduit 116b connected to the right lifting chamber 96b. A one-way valve 118a is provided on the left outlet conduit 116a and a one-way valve 118b is provided on the right outlet conduit 116b. The left outlet conduit 116a and the right outlet conduit 116b branch together to an upper supply conduit 120 at junction 122. As can be seen in FIG. 1, the pump member 106 is provided on the upper supply conduit 120. The upper supply conduit 120 is connected to the upper reservoir 78 for releasing the lifted liquid thereinto.

The lifting line arrangement 82 thus provides two alternative flow paths for the liquid from the lower reservoir 80 to the upper reservoir 78. The first flow path is constituted by a conduit arrangement including the lower supply conduit 108, the left inlet conduit 110a, the left lifting chamber 96a, the left outlet conduit 116a and the upper supply conduit 120. The second flow path is constituted by a conduit arrangement including the lower supply conduit 108, the right inlet conduit 110b, the right lifting chamber 96b, the right outlet conduit 116b and the upper supply conduit 120.

The lowering line arrangement 84 comprises a first line 34 according to the present disclosure in the form of an upper drain conduit. The first line 34 is connected to the upper reservoir 78 for receiving liquid therefrom. The first port 18 (not shown) of the rotary valve device 10 is thus in fluid communication with the lowering line arrangement 84 upstream of the pressure converter 76.

The lowering line arrangement 84 further comprises the rotary valve device 10 for sequentially connecting the first line 34 to two second lines 36a, 36b. The first line 34 is connected to the first port 18 (not shown) of the rotary valve device 10 and the second lines 36a, 36b are connected to the second ports 30a, 30b (not shown) of the rotary valve device 10.

The left second line 36a is connected to the left lowering chamber 96c and the right second line 36b is connected to the right lowering chamber 96d. The lowering line arrangement 84 further comprises a second line 66a connected to the left lowering chamber 96c and a second line 66b connected to the right lowering chamber 96d.

As described above, the rotary valve device 10 can sequentially connect the first line 34 to the second line 36a and to the second line 36b by rotating the distribution rotor 14 (not shown). In this manner, fluid from the first line 34 may be alternatingly distributed to the left lowering chamber 96c and to the right lowering chamber 96d of the lowering hollow body 90.

In FIG. 1, one-way valves 124a, 124b are provided on the left second line 36a and the right second line 36b, respectively, and one-way valves 126a, 126b are provided on the left second line 66a and the right second line 66b, respectively. However, the one-way valves 124a, 124b, 126a, 126b may optionally be omitted.

The two second lines 66a, 66b from the lowering hollow body 90 are connected to the two second ports 50a, 50b (not shown) of the rotary valve device 44. The first port 48 (not shown) of the rotary valve device 44 is connected to a first line 64 according to the present disclosure in the form of a lower drain conduit.

The first line 64 in FIG. 1 comprises a lower end submerged in the lower reservoir 80 for releasing the lowered liquid. However, the lower end of the first line 64 may be positioned above the surface of the lower reservoir 80 and does not need to be submerged in the lower reservoir 80.

By driving the motor 68, the shaft 38 is rotated together with the distribution rotors 14, 52 (not shown) of the respective rotary valve device 10, 44. The rotation of the distribution rotor 14 causes the liquid from the upper reservoir 78 led in the first line 34 to be alternatingly distributed to the left second line 36a and to the right second line 36b and consequently also alternatingly distributed to the left lowering chamber 96c and to the right lowering chamber 96d.

The distribution rotors 14, 52 are synchronized such that when the rotary valve device 10 establishes a fluid communication between the first line 34 and the left second line 36a to fill the left lowering chamber 96c, the rotary valve device 44 establishes a fluid communication between the right second line 66b and the first line 64 to drain the right lowering chamber 96d, and vice versa.

As the lowering displaceable member 98 reciprocates within the lowering hollow body 90, also the lifting displaceable member 94 reciprocates within the lifting hollow body 88 to pump liquid from the lower reservoir 80 to the upper reservoir 78.

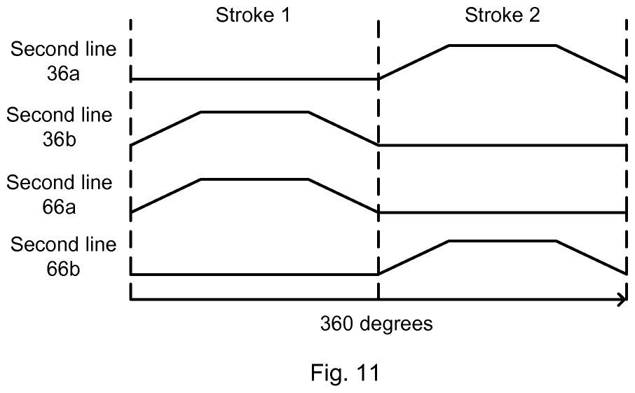

FIG. 11 shows an example of flow pattern of the rotary valve devices 10, 44 in FIG. 10. The flows through the second lines 36a, 36b, 66a, 66b correspond to the respective flows through the second ports 30a, 30b, 50a, 50b. In this configuration, there are only two strokes per revolution of the distribution rotors 14, 52.

In the first stroke, a fluid communication between the first line 34 and the right second line 36b is successively established to provide a flow into the right lowering chamber 96d. At the same time, a fluid communication between the left second line 66a and the first line 64 is successively established to drain the left lowering chamber 96c. The opening between the first line 34 and the right second line 36b is proportional to the opening between the left second line 66a and the first line 64.

When the distribution rotors 14, 52 have rotated a certain amount, these fluid communications are fully open to provide a maximum inflow to the right lowering chamber 96d and a maximum outflow from the left lowering chamber 96c. When the distribution rotors 14, 52 have rotated further, the flow through the established fluid communications start to decrease until they are closed. During the first stroke, the lowering displaceable member 98 moves to the left (arrow 104).

In the second stroke, a fluid communication between the first line 34 and the left second line 36a is successively established to provide a flow into the left lowering chamber 96c. At the same time, a fluid communication between the right second line 66b and the first line 64 is successively established to drain the right lowering chamber 96d. When the distribution rotors 14, 52 have rotated a certain amount, these fluid communications are fully open to provide a maximum inflow to the left lowering chamber 96c and a maximum outflow from the right lowering chamber 96d. When the distribution rotors 14, 52 have rotated further, the flow through the established fluid communications start to decrease until they are closed. During the second stroke, the lowering displaceable member 98 moves to the right (arrow 102). This process enables a balanced filling and drainage on both sides of the displaceable member 98.

As described above, the rotary valve device 10 may additionally be configured to establish a fluid communication between the first line 34 and the left second line 36a before closing an established fluid communication between the first port 18 and the right second line 36b, and vice versa, as the distribution rotor 14 rotates.

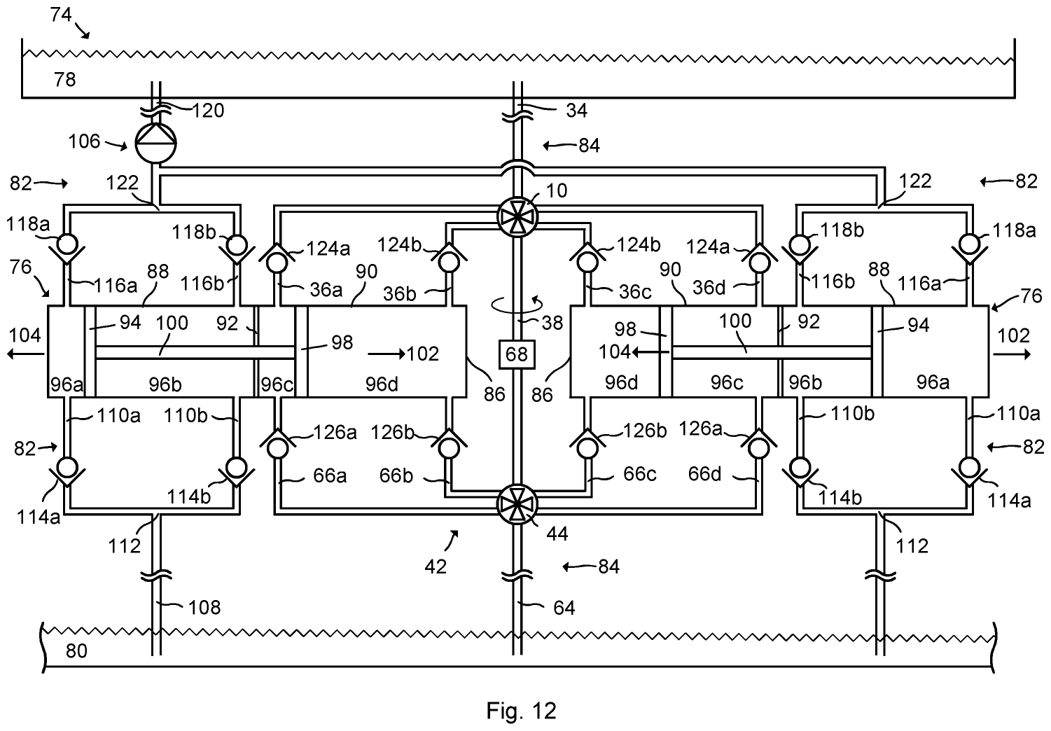

FIG. 12 schematically represents a lifting device 74 comprising two pressure converters 76 and a rotary valve assembly 42 in accordance with FIG. 6 having two rotary valve devices 10, 44. The lifting device 74 may alternatively comprise more than two pressure converters 76.

The rotary valve devices 10, 44 of FIG. 12 comprises four second ports 30a, 30b, 30c, 30d, 66a, 66b, 66c, 66d (not shown). The lifting device 74 further comprises two lifting line arrangements 82 which are similar to the lifting line arrangement 82 in FIG. 10 except that the lines from the two junctions 122 are branched together downstream of the pump member 106.

The section of the lowering line arrangement 84 between the upper reservoir 78 and the pressure converters 76 may be referred to as a charge side of the lifting device 74 and the section of the lowering line arrangement 84 between the pressure converters 76 and the lower reservoir 80 may be referred to as a return side of the lifting device 74.

The second port 30a (not shown) of the rotary valve device 10 is connected to the second line 36a, the second port 30b (not shown) of the rotary valve device 10 is connected to the second line 36b, the second port 30c (not shown) of the rotary valve device 10 is connected to the second line 36c, and the second port 30d (not shown) of the rotary valve device 10 is connected to the second line 36d. Thus, two of the second ports 30a, 30b (not shown) of the rotary valve device 10 is in fluid communication with a respective chamber 96c, 96d of the left pressure converter 76 and two of the second ports 30c, 30d (not shown) of the rotary valve device 10 is in fluid communication with a respective chamber 96c, 96d of the right pressure converter 76.

Similarly, the second port 50a (not shown) of the rotary valve device 44 is connected to the second line 66a, the second port 50b (not shown) of the rotary valve device 44 is connected to the second line 66b, the second port 50c (not shown) of the rotary valve device 44 is connected to the second line 66c, and second port 50d (not shown) of the rotary valve device 10 is connected to the second line 66d.

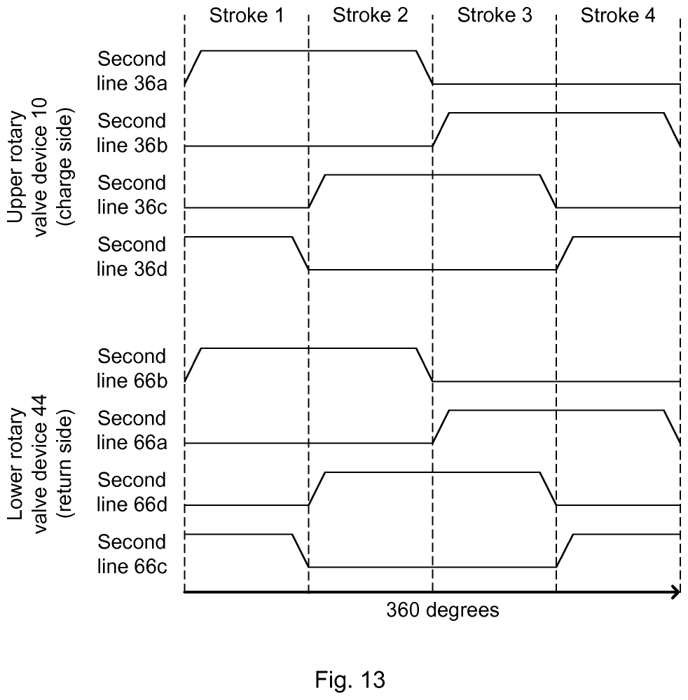

FIG. 13 shows an example of flow pattern of the rotary valve devices 10, 44 in FIG. 12. In detail, FIG. 13 shows that the second lines 36a, 66b open at the beginning of the first stoke, the second lines 36d, 66c close at the end of the first stoke, the second lines 36c, 66d open at the beginning of the second stroke, the second lines 36a, 66b close at the end of the second stroke, the second lines 36b, 66a open at the beginning of the third stroke, the second lines 36c, 66d close at the end of the third stroke, the second lines 36d, 66c open at the beginning of the fourth stroke, and the second lines 36b, 66a close at the end of the fourth stroke. This is one type of synchronized control of the rotary valve devices 10, 44.

The upper rotary valve device 10 (on the charge side) may thus work as follows. In the first stroke, a fluid communication is established between the first line 34 and the second line 36a to the left pressure converter 76. In the second stroke, a fluid communication is established between the first line 34 and the second line 36c of the right pressure converter 76. In case further pressure converters 76 are used in the lifting device 74, fluid communications may be established to one of the chambers 96c, 96d of each further pressure converters 76 in following strokes. This establishment of fluid communications therefore constitutes a first opening sequence where fluid communications are sequentially established between the first port 18 (not shown) and each of the second ports 30 (not shown) associated with a first chamber 96c, 96d of each pressure converter 76.

Furthermore, in the third stroke, after fluid communication between the first line 34 and the second line 36a is closed, a fluid communication is established between the first line 34 and the second line 36b to the left pressure converter 76. In the fourth stroke, a fluid communication is established between the first line 34 and the second line 36d of the right pressure converter 76. In case further pressure converters 76 are used in the lifting device 74, fluid communications may be established to the “other” chamber 96c, 96d (i.e. not pressurized in the first opening sequence) of each further pressure converters 76 in following strokes. This establishment of fluid communications therefore constitutes a second opening sequence where fluid communications are sequentially established between the first port 18 (not shown) and each of the second ports 30 (not shown) associated with a second chamber 96c, 96d of each pressure converter 76.

FIG. 13 further illustrates that the lower rotary valve device 44 may work as follows. At the end of the fourth stroke (or at the beginning of the first stroke), a fluid communication between the first line 64 and the second line 66a from the left pressure converter 76 is closed. At the end of the first stroke (or at the beginning of the second stroke), a fluid communication between the first line 34 and the second line 66c from the right pressure converter 76 is closed. In case further pressure converters 76 are used in the lifting device 74, fluid communications from one of the chambers 96c, 96d of each further pressure converter 76 may be closed in following strokes. This closing of fluid communications therefore constitutes a first closing sequence where fluid communications between the first port 48 (not shown) and each of the second ports 50 (not shown) associated with a first chamber 96c, 96d of each pressure converter 76 are closed.

Furthermore, at the end of the second stroke (or at the beginning of the third stroke), a fluid communication between the first line 64 and the second line 66b from the left pressure converter 76 is closed. At the end of the third stroke (or at the beginning of the fourth stroke), a fluid communication between the first line 64 and the second line 66d from the right pressure converter 76 is closed. In case further pressure converters 76 are used in the lifting device 74, fluid communications from the “other” chamber 96c, 96d (i.e. not closed in the first closing sequence) of each further pressure converter 76 may be closed in following strokes. This closing of fluid communications therefore constitutes a second closing sequence where fluid communications between the first port 48 (not shown) and each of the second ports 50 (not shown) associated with a second chamber 96c, 96d of each pressure converter 76 are closed.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A rotary valve device for sequentially connecting a first line to a plurality of second lines, the rotary valve device comprising:
a stationary structure comprising a first port for connection to the first line and at least two second ports for connection to a respective second line; and
a distribution rotor rotatably arranged within the stationary structure, the distribution rotor comprising at least one rotor opening; wherein the rotary valve device is configured such that the rotor opening sequentially establishes a fluid communication between the first port and the second ports as the distribution rotor rotates.

2. The rotary valve device according to claim 1, wherein the rotary valve device is configured to establish a fluid communication between the first port and one of the second ports before closing an established fluid communication between the first port and another of the second ports as the distribution rotor rotates.

3. The rotary valve device according to claim 1, wherein the distribution rotor is arranged to rotate continuously.

4. The rotary valve device according to claim 1, wherein the rotor opening comprises a radially wide portion between two radially narrow portions along a rotational direction of the distribution rotor.

5. The rotary valve device according to claim 1, wherein the rotor opening comprises a radially outer profile having a shape based on a sine function.

6. The rotary valve device according to claim 5, wherein the rotor opening comprises a radially inner profile having an arc shape.

7. The rotary valve device according to claim 1, further comprising a stator member fixedly arranged within the stationary structure, downstream of the distribution rotor, wherein the stator member comprises a stator opening associated with each second port.

8. The rotary valve device according to claim 7, wherein:
the rotor opening comprises: (i) a radially wide portion between two radially narrow portions along a rotational direction of the distribution rotor, (ii) a radially outer profile having a shape based on a sine function, or (iii) a radially inner profile having an arc shape, and
the stator opening has the same shape as the rotor opening.

9. The rotary valve device according to claim 1, wherein the rotary valve device is configured such that a fluid communication between the first port and one or more of the second ports is always established as the distribution rotor rotates.

10. A rotary valve assembly comprising two rotary valve devices according to claim 1, wherein the distribution rotors of the rotary valve devices are arranged to rotate synchronously.

11. The rotary valve assembly according to claim 10, further comprising a shaft, wherein the distribution rotors of the rotary valve devices are connected via the shaft to rotate synchronously.

12. The rotary valve assembly according to claim 11, further comprising a hollow shaft motor configured to rotationally drive the shaft.

13. The rotary valve assembly according to claim 10, wherein the rotary valve devices are connected in fluid series, wherein the second ports of the first rotary valve device are outlet ports and the second ports of the second rotary valve device are inlet ports.

14. The rotary valve assembly according to claim 13, wherein at least two of the second ports of the first rotary valve device are in fluid communication with a respective second port of the second ports of the second rotary valve device.

15. The rotary valve assembly according to claim 14, wherein the rotary valve devices are configured to simultaneously fill a first intermediate volume, between a first of the second ports of the first rotary valve device and a first of the second ports of the second rotary valve device, and drain a second intermediate volume, between a second of the second ports of the first rotary valve device and a second of the second ports of the second rotary valve device, and vice versa.

16. The rotary valve assembly according to claim 10, wherein the two rotary valve devices are stacked.

17. A lifting device for vertically lifting liquids, the lifting device comprising:
a lifting line arrangement for guiding a liquid from a lower reservoir to an upper reservoir;
a lowering line arrangement for guiding the liquid from the upper reservoir to the lower reservoir;
a pressure converter configured to convert a liquid pressure in the lowering line arrangement into a liquid pressure in the lifting line arrangement, the pressure converter comprising a hollow body and a displaceable member movable within the hollow body in order to substantially sealingly divide the hollow body into two chambers of variable volumes; and
a rotary valve device according to claim 1; wherein the first port is in fluid communication with the lowering line arrangement, upstream of the pressure converter, and two of the second ports are in fluid communication with a respective chamber of the pressure converter.

18. A lifting device for vertically lifting liquids, the lifting device comprising:
a lifting line arrangement for guiding a liquid from a lower reservoir to an upper reservoir;
a lowering line arrangement for guiding the liquid from the upper reservoir to the lower reservoir;
a plurality of pressure converters, each configured to convert a liquid pressure in the lowering line arrangement into a liquid pressure in the lifting line arrangement, wherein each pressure converter comprises a hollow body and a displaceable member movable within the hollow body in order to substantially sealingly divide the hollow body into two chambers of variable volumes; and
a rotary valve device according to claim 1; wherein the first port is in fluid communication with the lowering line arrangement, upstream of the pressure converters, and two of the second ports are in fluid communication with a respective chamber of each pressure converter.

19. A lifting device for vertically lifting liquids, the lifting device comprising:
a lifting line arrangement for guiding a liquid from a lower reservoir to an upper reservoir;
a lowering line arrangement for guiding the liquid from the upper reservoir to the lower reservoir;
a pressure converter configured to convert a liquid pressure in the lowering line arrangement into a liquid pressure in the lifting line arrangement, the pressure converter comprising a hollow body and a displaceable member movable within the hollow body in order to substantially sealingly divide the hollow body into two chambers of variable volumes; and
a rotary valve assembly according to claim 10; wherein the first port of the first rotary valve device is in fluid communication with the lowering line arrangement, upstream of the pressure converter, two of the second ports of the first rotary valve device are in fluid communication with a respective chamber of the pressure converter, two of the second ports of the second rotary valve device are in fluid communication with a respective chamber of the pressure converter, and the first port of the second rotary valve device is in fluid communication with the lowering line arrangement, downstream of the pressure converter.

20. A lifting device for vertically lifting liquids, the lifting device comprising:
a lifting line arrangement for guiding a liquid from a lower reservoir to an upper reservoir;
a lowering line arrangement for guiding the liquid from the upper reservoir to the lower reservoir;
a plurality of pressure converters, each configured to convert a liquid pressure in the lowering line arrangement into a liquid pressure in the lifting line arrangement, wherein each pressure converter comprises a hollow body and a displaceable member movable within the hollow body in order to substantially sealingly divide the hollow body into two chambers of variable volumes; and
a rotary valve assembly according to claim 10; wherein the first port of the first rotary valve device is in fluid communication with the lowering line arrangement, upstream of the pressure converters, two of the second ports of the first rotary valve device are in fluid communication with a respective chamber of each pressure converter, two of the second ports of the second rotary valve device are in fluid communication with a respective chamber of each pressure converter, and the first port of the second rotary valve device is in fluid communication with the lowering line arrangement, downstream of the pressure converters.

21. A method of controlling the lifting device according to claim 18, the method comprising:
in a first sequence, sequentially establishing a fluid communication between the first port and each of the second ports associated with the first chamber of each pressure converter by rotating the distribution rotor; and
in a second sequence, following the first sequence, sequentially establishing a fluid communication between the first port and each of the second ports associated with the second chamber of each pressure converter by rotating the distribution rotor.

22. A method of controlling the lifting device according to claim 20, the method comprising:
in a first opening sequence, sequentially establishing a fluid communication between the first port of the first rotary valve device and each of the second ports of the first rotary valve device associated with the first chamber of each pressure converter by rotating the distribution rotor; and
in a second opening sequence, following the first opening sequence, sequentially establishing a fluid communication between the first port of the first rotary valve device and each of the second ports of the first rotary valve device associated with the second chamber of each pressure converter by rotating the distribution rotor.

23. The method according to claim 22, further comprising:
in a first closing sequence, sequentially closing a fluid communication between the second port of the second rotary valve device associated with the first chamber of each pressure converter by rotating the distribution rotor; and
in a second closing sequence, following the first closing sequence, sequentially closing a fluid communication between the second port of the second rotary valve device associated with the second chamber of each pressure converter by rotating the distribution rotor.

24. The method according to claim 23, wherein the first opening sequence and the first closing sequence are carried out simultaneously, and wherein the second opening sequence and the second closing sequence are carried out simultaneously, such that a fluid communication between the first port of the first rotary valve device and the second port of the first rotary valve device associated with the first chamber of one pressure converter is established substantially at the same time as the fluid communication between the second port of the second rotary valve device associated with the first chamber of the pressure converter and the first port of the second rotary valve device is closed.
